(19) United States
(12) Patent Application Publication
(10) Pub. No.: US 2008/0216084 A1
(43) Pub. Date: Sep. 4, 2008

(54) MEASURE SELECTION PROGRAM, MEASURE SELECTION APPARATUS, AND MEASURE SELECTION METHOD

(75) Inventors: Takashi Tada, Kawasaki (JP); Koichi Matsuda, Kawasaki (JP); Etsuo Watanabe, Kawasaki (JP); Hyuma Tsujii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/040,159

(22) Filed: Feb. 29, 2008

(30) Foreign Application Priority Data
Mar. 2, 2007 (JP) 2007-53154

(51) Int. Cl. G06F 9/46

(52) U.S. Cl. 718/104

(57) ABSTRACT

A combination of measures are selected to set a recovery time of a business to be equal to or shorter than a time objective when a predetermined event occurs. A dependency relationship is shown between an operation constituting the business and resources necessary to continue the operation. Scenario information holds the recovery time required for a recovery when the predetermined event occurs for each of the resources. Measure information holds measures for reducing the recovery time and effects of the respective measures for each of the resources. Paths connecting a highest node to a terminal node of the resources included in the operation element related information are extracted according to the dependency relationship; and the combination of measures are selected so that a recovery time sum of the respective resources is equal to or shorter than the time objective on all the paths extracted by the resource path extraction procedure.

### BACKGROUND OF THE INVENTION

1. Field of the Invention

The present invention relates to a measure selection program, a measure selection apparatus, and a measure selection method for selecting a combination of measures for setting business recovery time at the time of occurrence of a predetermined event to be equal to or shorter than recovery time objective. More specifically, the present invention relates to a measure selection program, a measure selection apparatus, and a measure selection method capable of efficiently selecting an optimum combination of measures for setting the business recovery time to be equal to or shorter than the time objective.

2. Description of the Related Art

There is a known technique for modeling contents of an operation and visualizing the contents in the form of a diagram or the like with a view of grasping and improving business operations. For example, Japanese Patent Application Laid-Open No. 2003-308421 discloses a technique for visualizing a workflow, and Japanese Patent Application Laid-Open No. 2006-048145 discloses a technique for modeling contents of a business with the aim of optimizing business activities.

One such aim of business modeling is the establishment of a BCP (Business Continuity Plan). A BCP is a plan for continuing a business without intermission as much as possible when various risks occur. To establish the BCP, a diagram called an “influence diagram” is normally created and tasks are extracted and measures (measures for controlling the risks and/or measures for mitigating the business damage) are planned based on the influence diagram.

The influence diagram used in the BCP expresses a dependency relationship between processes included in the business and resources necessary to pursue the processes in a predetermined format. Use of the influence diagram can facilitate simulating an influence of a trouble that may occur to one of the resources on business continuity.

### SUMMARY

To establish a BCP based on the influence diagram, it is necessary to select an optimum combination from among possible combinations of measures. However, the conventional technique has the following disadvantages. If a business is large in scale, then a great number of possible combinations of measures are present, and the dependency relationship of the resources included in the influence diagram is complicated. As a result, it takes lots of time and labor to evaluate the measures and it is quite difficult to select the most effective combination of measures.

To solve the conventional disadvantages and to attain the object, according to one aspect of the present invention, there is provided a storage medium storing a program for causing a computer to execute a process for selecting a combination of measures so as to set a recovery time of a business when a predetermined event occurs to be equal to or shorter than a time objective based on operation element related information showing a dependency relationship between an operation constituting the business and resources necessary to continue the operation, scenario information holding the recovery time required for a recovery when the predetermined event occurs for each of the resources, and measure information holding measures for reducing the recovery time and effects of the respective measures for each of the resources. The program causes the computer to execute: a resource path extraction procedure of extracting paths connecting a highest node to a terminal node of the resources included in the operation element related information according to the dependency relationship; and a measure selection process control procedure of controlling the process for selecting the combination of measures so that a recovery time sum of the respective resources is equal to or shorter than the time objective on all the paths extracted by the resource path extraction procedure.

It is to be noted that it is also effective to apply the constituent elements, expressions or arbitrary combinations of constituent elements according to the present invention to a method, an apparatus, a system, a recording medium or the like as another aspect of the present invention.

The above-described embodiments of the present invention are intended as examples, and all embodiments of the present invention are not limited to including the features described above.

### BRIEF DESCRIPTION OF THE DRAWINGS

FIG. 1 is a schematic diagram showing an example of an influence diagram;

FIG. 2 is a functional block diagram showing a configuration of a measure selection apparatus according to an embodiment of the present invention;

FIG. 3 is a table showing an example of operation element data;

FIG. 4 is a table showing an example of operation element related data;

FIG. 5 is a table showing an example of a resource masters;

FIG. 6 is a table showing an example of resource path data;

FIG. 7 is a table showing an example of scenario data;

FIG. 8 is a table showing an example of measure data;

FIG. 9 is a table showing an example of optimum measure data;

FIG. 10 is a table showing an example of a measure effect master;

FIG. 11 is a flowchart showing processing procedures performed by the measure selection apparatus;

FIG. 12 is a flowchart showing processing procedures for an optimum measure selection process; and

FIG. 13 is a functional block diagram showing a computer executing a measure selection program.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

A measure selection program, a measure selection apparatus, and a measure selection method according to preferred embodiments of the present invention will be described hereinafter in detail with reference to the accompanying drawings.

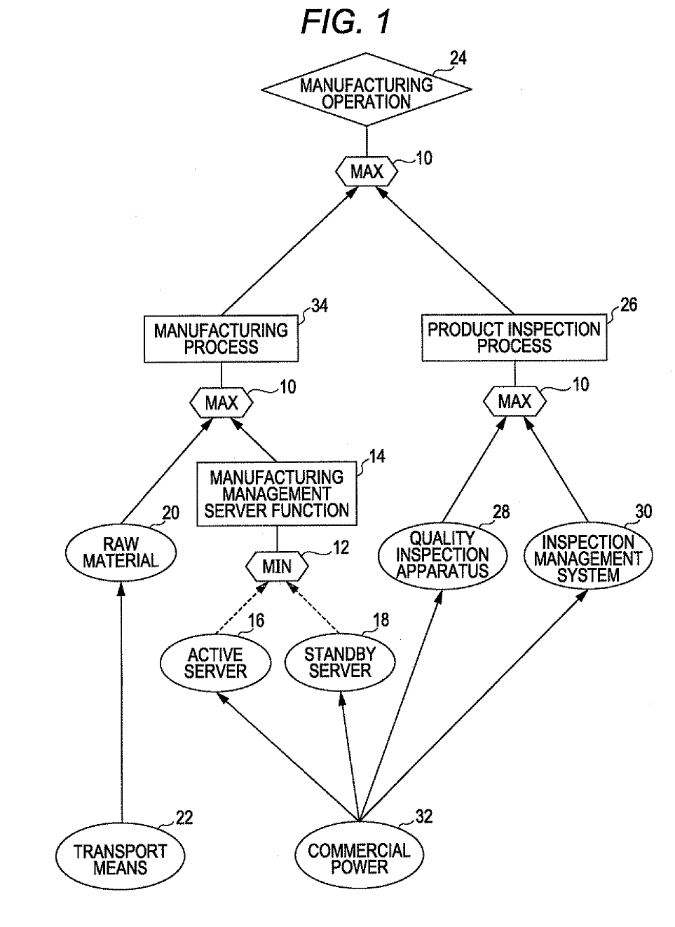

An influence diagram used in a BCP will first be described. FIG. 1 is an example of the schematic diagram showing an example of the influence diagram. The influence diagram is a diagram expressing dependency relationships between processes included in a business and resources necessary to pursue the processes. The influence diagram of this type is used to evaluate an influence of each risk occurring during continuation of the business as recovery time.

In the influence diagram, a diamond represents an evaluation node, a rectangle represents a definite node, an eclipse represents an indefinite node, and a hexagon represents an efficacy node. The evaluation node is a node at which an influence of a risk is evaluated. The definite node is a node at which an influence on its node is defined by defining an influence of the node on a lower node. The indefinite node is a node at which a magnitude of an influence on its node fluctuates according to a risk. The efficacy node is a node having a predetermined efficacy. In the example of FIG. 1, an efficacy node “MAX” for selecting a maximum value and an efficacy node “MIN” for selecting a minimum value are used.

The processes and the resources will now be considered. If a certain risk occurs, it is a resource that is directly influenced by the risk. A recovery time of a process is decided by that of a resource on which the process depends. More specifically, to recover a process, it is necessary to recover all the resources on which the process depends. Due to this, the recovery time of the process coincides with a maximum value of the recovery time of the resources on which the process depends. Accordingly, the example of FIG. 1 illustrates that a process expressed as the definite node is connected to a resource or resources expressed as the indefinite node or indefinite nodes via the efficacy node MAX 10.

Furthermore, a recovery time of a business for which a magnitude of the influence of a risk on the business is finally evaluated corresponds to a maximum value of recovery time of all the processes included in the business. Accordingly, the example of FIG. 1 illustrates that the business expressed as the evaluation node is connected to the processes expressed as the definite nodes via the efficacy nodes MAX 10, respectively.

Moreover, if a replaceable process or resource is present, a function of the process or resource is recovered as long as one of a replacement process and a replacement resource is recovered. Accordingly, the example of FIG. 1 illustrates that nodes expressing a replacement process or a replacement resource are connected to a higher node via an efficacy node MIN 12. For example, a resource active server 16 and a resource standby server 18 are replaceable with each other and that the indefinite nodes expressing these respective resources are, therefore, connected to a higher definite node of manufacturing management server function 14 via an efficacy node MIN 12.

Further, if a certain resource is to fulfill its function, a function of the other resource is often necessary. If a dependency relationship is held between the resources in this manner, the example of FIG. 1 illustrates that the resources having the dependency are connected to each other. For example, a resource raw material 20 depends on a resource transport means 22, so that an indefinite node expressing the resource raw material 20 is connected to an indefinite node expressing the resource transport means 22.

In the example of FIG. 1, the resource raw material 20 cannot be recovered until the resource transport means 22 is recovered. Due to this, a recovery time of the resource raw material 20 is evaluated as a value obtained by adding a recovery time of the resource transport means 22 to that of the resource raw material 20 itself.

By creating such an influence diagram, the recovery time of the business at the time of occurrence of a risk can be obtained by calculation. Specifically, the recovery time (hereinafter, “RT”) of a manufacturing operation 24 expressed by the evaluation node can be calculated according to the following equation.

$$RT of manufacturing operation 24 = MAX ( RT of manufacturing operation 24 , RT of product inspection process 26 ) = MAX ( MAX ( RT of raw material 20 + RT of transport means 22 , RT of manufacturing management server function 14 ) , MAX ( RT of quality inspection apparatus 28 + RT of commercial power 32 , RT of inspection management system 30 + RT of commercial power 32 ) ) = MAX ( MAX ( RT of raw material 20 + RT of transport means 22 , MIN ( RT of active server 16 + RT of commercial power 32 , RT of standby server 18 + RT of commercial power 32 ) ) , MAX ( RT of quality inspection apparatus 28 + RT of commercial power 32 , RT of inspection management system 30 + RT of commercial power ) )$$

The influence diagram shown in FIG. 1 has a simple structure for convenience of description. The influence diagram actually expressing a business is far more complicated than that shown in FIG. 1, and an equation for calculating the RT is more complicated. It is quite difficult to search an optimum combination from among a vast number of existing combinations of measures for such a complicated model as a recovery time objective.

If attention is now paid to the fact that a minimum value does not exceed a maximum value, the above expression can be transformed to the following equation.

$$RT of manufacturing operation 24 \leq MAX ( MAX ( RT of raw material 20 + RT of transport means 22 , MAX ( RT of active server 16 + RT of commercial power 32 , RT of standby server 18 + RT of commercial power 32 ) ) , MAX ( RT of quality inspection apparatus 28 + RT of commercial power 32 , RT of inspection management system 30 + RT of c ommercial power ) )$$

By further transforming this equation, the following equation can be obtained.

$$RT of manufacturing operation 24 \leq MAX ( RT of raw material 20 + RT of transport means 22 , RT of active server 16 + RT of commercial power 32 , RT of standby server 18 + RT of commercial power 32 \\ RT of quality inspection apparatus 28 + RT of commercial power 32 , RT of inspection management system 30 + RT of commercial power 32 )$$

Each element of MAX is a sum of recovery time of the resources on each path from a highest node to a terminal node included in the influence diagram according to the dependency relationship. For example, a first element is a sum of recovery time of the resource raw material 20 and that of the resource transport means 22 on a path of manufacturing operation 24→MAX 10→manufacturing process 34→MAX 10→raw material 20→transport means 22. A fifth element is a sum of the recovery time of the resource inspection management system 30 and that of the resource commercial power 32 on a path of manufacturing operation 24→MAX 10→product inspection process 26→MAX 10→inspection management system 30→commercial power 32.

Namely, the equation indicates that the recovery time of the business does not exceed a maximum value of the sum of the recovery time of the resources on the respective paths from the highest node to the terminal node included in the influence diagram according to the dependency relationship. Due to this, to set the recovery time of the business shorter than a certain recovery time objective, it suffices to select measures so that the maximum value of the sum is below the time objective when the sum of the recovery time of the resources is calculated for every path.

In this manner, by simplifying the model, it is possible to facilitate evaluating effects of measures, and to efficiently select an optimum combination for obtaining necessary improvements from among a vast number of existing combinations of measures.

A configuration of a measure selection apparatus 100 according to the embodiment will be described. The measure selection apparatus 100 is an apparatus for selecting an optimum combination of measure so that recovery time capability (hereinafter, “RTC”) that is recovery time of the business assumed at the time of occurrence of such a risk as an earthquake is below the recovery time objective (hereinafter “RTO”).

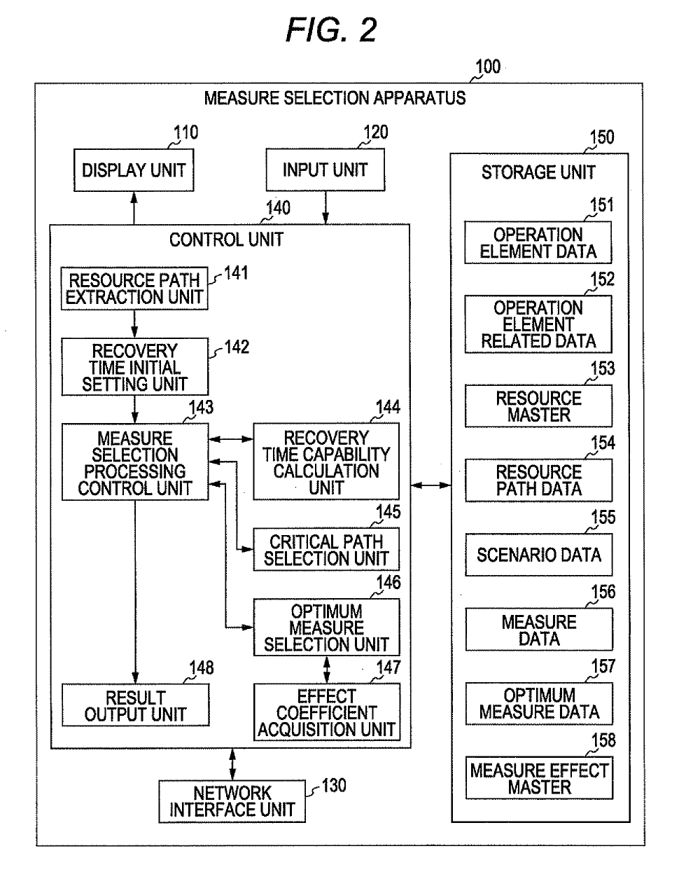

FIG. 2 is one example of a functional block diagram showing the configuration of the measure selection apparatus 100 according to the embodiment. As shown in FIG. 2, the measure selection apparatus 100 includes a display unit 110, an input unit 120, a network interface unit 130, a control unit 140, and a storage unit 150.

The display unit 110 is a device that displays various pieces of information and is, for example, a liquid crystal display. The input unit 120 is a device to which a user inputs various instructions and the like and is, for example, a keyboard and a mouse. The network interface unit 130 is an interface for exchanging information and the like with the other apparatus via a network.

The control unit 140 controls the entire measure selection apparatus 100, and includes a resource path extraction unit 141, a recovery time initial setting unit 142, a measure selection processing control unit 143, a recovery time capability calculation unit 144, a critical path selection unit 145, an optimum measure selection unit 146, an effect coefficient acquisition unit 147, and a result output unit 148.

The storage unit 150 stores therein various pieces of information. Specifically, the storage unit 150 stores therein operation element data 151, operation element related data 152, a resource master 153, resource path data 154, scenario data 155, measure data 156, optimum measure data 157, and a measure effect master 158.

Respective constituent elements of the control unit 140 will be described in detail. The resource path extraction unit 141 is a processing unit that extracts resource paths from the operation element data 151 and operation element related data 152 that constitute the influence diagram, and that stores the extracted resource paths in the resource path data 154. The “resource path” means a path connecting the resources included in the influence diagram from the highest node to the terminal node according to the dependency relationship.

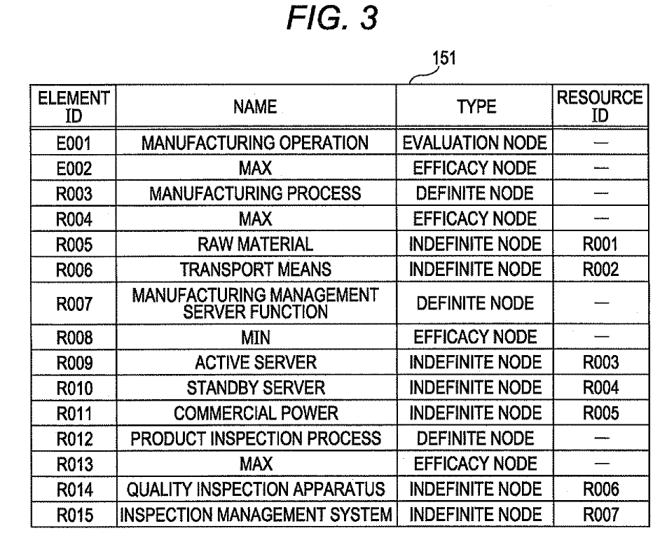

FIG. 3 shows an example of the operation element data 151. As shown in FIG. 3, the operation element data 151 includes such items as an element ID item, a name item, a type item, and a resource ID item, and a row is registered per node of the influence diagram. Data stored in each element ID cell is an identification number for identifying each node. Data stored in each name cell is a name of each node, which is equal in value to a character sequence displayed in a symbol of the node in the influence diagram.

Data stored in each type cell is a type of each node, which is one of “evaluation node”, “definite node”, “indefinite node”, and “efficacy node”. Data stored in each resource ID cell is set if the value of the type is “indefinite node”, that is, if the node is a resource, and corresponds to a resource ID of the resource master 153 to be described later.

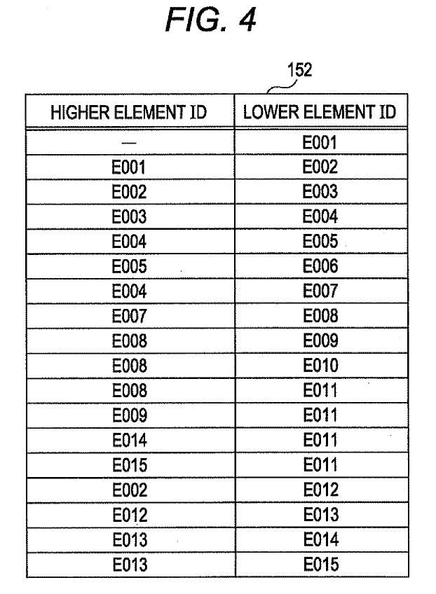

FIG. 4 shows an example of the operation element related data 152. As shown in FIG. 4, the operation element related data 152 includes such items as a higher element ID item and a lower element ID item. Each row represents an internode connection in the influence diagram. A higher element ID or a lower element ID corresponds to the data stored in each element ID cell of the operation element data 151.

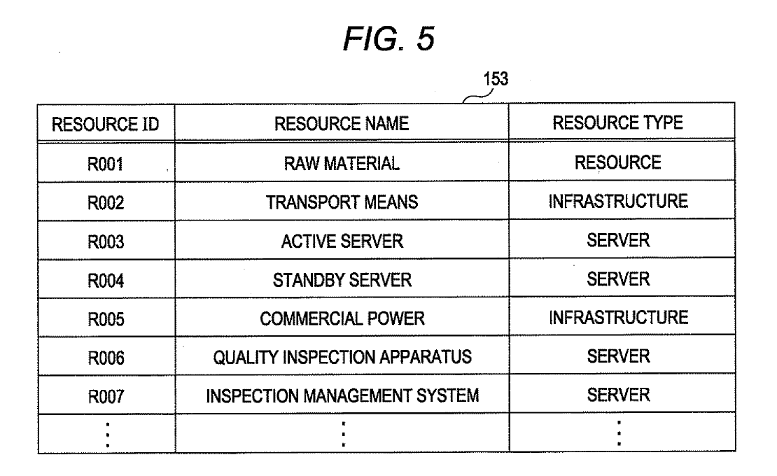

FIG. 5 shows an example of the resource master 153. As shown in FIG. 5, the resource master 153 includes such items as a resource ID item, a resource name item, and a resource type item, and is a master in which a list of data related to resources that can be added to the influence diagram is registered in advance. Data stored in each resource ID cell is an identification number for identifying each resource. Data stored in each resource name cell is a name of each resource. Data stored in each resource type cell is a type of each resource.

Referring again to FIG. 2, the resource path extraction unit 141 searches all the paths downward from the evaluation node while referring to the operation element related data 152. The resource path extraction unit 141 stores the nodes representing resources in the resource path data 154, that is, information on nodes types of which are “indefinite nodes” while being associated with a corresponding path.

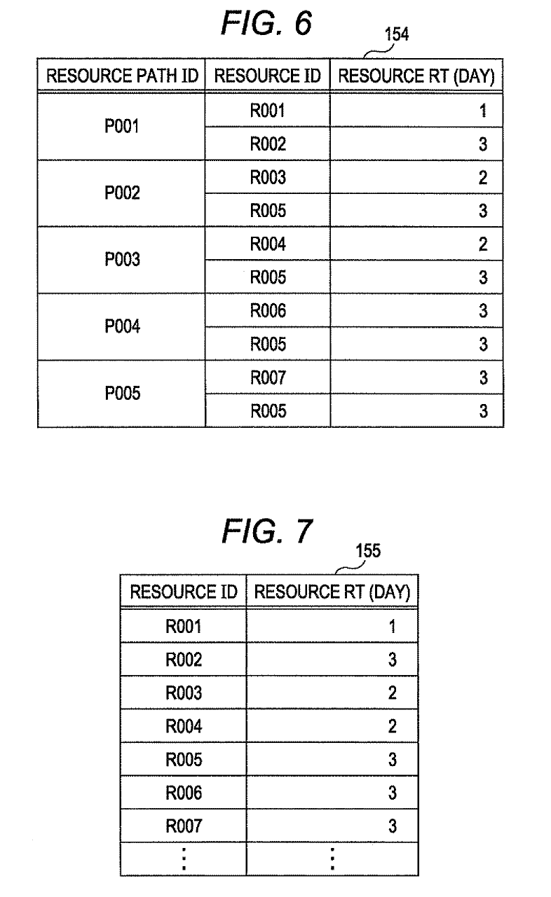

FIG. 6 shows an example of the resource path data 154. As shown in FIG. 6, the resource path data 154 includes such items as a resource path ID item, a resource ID item, and a resource RT item, and is configured to be able to register a plurality of combinations of resource IDs and resource RT for every resource path ID. Data stored in each resource path ID cell is an identification number for identifying each resource path. Data stored in each resource ID cell is an identification number indicating a resource on each resource path, and corresponds to the resource ID stored in the resource master 153. Data stored in each resource RT cell is time required for recovery of each resource if a predetermined risk occurs, and set to zero as an initial value by the resource path extraction unit 141.

FIG. 6 shows an example in which five types of resource path IDs are stored in the resource path data 154. This indicates that five paths connecting the evaluation node to the indefinite node that is the terminal node are present in all. Further, FIG. 6 shows an example in which two resource IDs “R001” and “R002” correspond to a resource path ID “P001”. This indicates that the resource path identified by the resource path ID “P001” includes two resources identified by the resource IDs “R001” and “R002”, respectively.

The examples of the operation element data 151 and the operation element related data 152 shown in FIGS. 3 and 4, respectively illustrate the data constituting the influence diagram shown in FIG. 1. The example of the resource path data 154 shown in FIG. 6 illustrates the resource paths extracted from these data.

Referring again to FIG. 2, the recovery time initial setting unit 142 is a processing unit that sets time required for recovery of each resource in the resource RT cell of the resource path data 154 based on the scenario data 155 if a predetermined risk occurs. The scenario data 155 is data in which the recovery time assumed to be necessary if a certain types of risk (e.g., a fire or an earthquake) occur is registered for every resource in advance.

FIG. 7 shows an example of the scenario data 155. As shown in FIG. 7, the scenario data 155 includes such items as a resource ID item and a resource RT item, and data shown in each row is registered per resource. Data stored in each resource ID cell is an identification number for identifying each resource, and corresponds to the resource ID stored in the resource master 153. Data stored in each resource RT cell is time required for recovery of each resource at the time of occurrence of a risk.

Referring again to FIG. 2, the recovery time initial setting unit 142 compares the resource path data 154 with the scenario data 155 with each resource ID set as a key, and transcribes a value of the resource RT from the scenario data 155 on the resource path data 154.

The measure selection process control unit 143 is a control unit that controls the recovery time capability calculation unit 144, the critical path selection unit 145, and the optimum measure selection unit 146 to repeatedly execute their process until RTC of all the resource paths included in the resource path data 154 is below the RTO.

The recovery time capability calculation unit 144 is a processing unit that calculates the RTC of each of the paths included in the resource path data 154. Specifically, the recovery time capability calculation unit 144 calculates a sum of the RT of the resources included in the resource path data 154 for every resource path, and sets a value of the sum as RTC of the resource path.

The critical path selection unit 145 is a processing unit that compares the RCT of the respective resource paths calculated by the recovery time capability calculation unit 144 and that selects a resource path having the highest RTC.

The optimum measure selection unit 146 is a processing unit that selects a measure having a highest effect from among the measures applicable to the resources included in the resource path selected by the recovery time capability calculation unit 144 from the measure data 156, and that stores the selected measure in the optimum measure data 157. The measure data 156 is data in which each resource as well as measures, effects and the like corresponding to the resource is registered in advance.

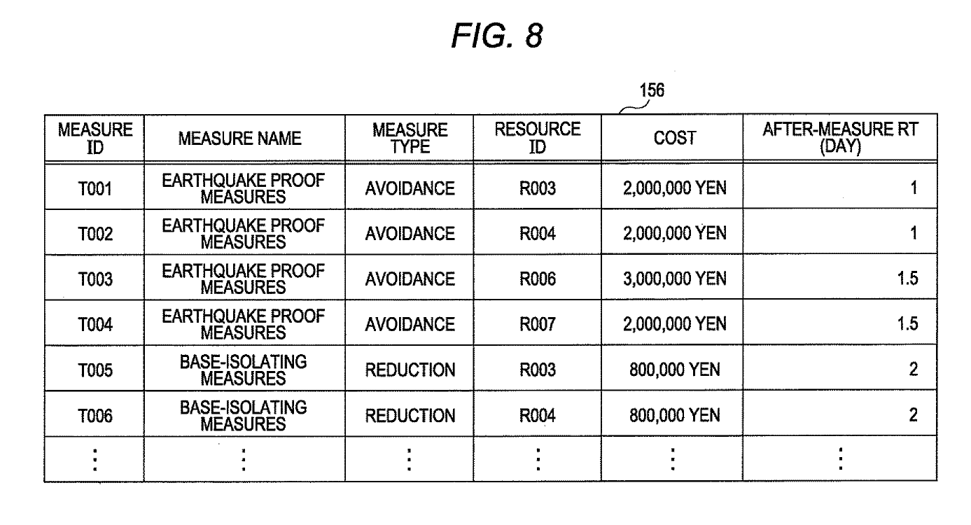

FIG. 8 shows an example of the measure data 156. As shown in FIG. 8, the measure data 156 includes such items as a measure ID item, a measure name item, a measure type item, a resource ID item, a cost item, and an after-measure RT item. Data shown in each row is registered per measure. Data stored in each measure ID cell is an identification number for identifying each measure. Data stored in each measure name cell is a name of each measure. Data stored in each measure type cell represents a type of each measure. Data stored in each resource ID cell is an identification number indicating a resource for which the measure is taken, and corresponds to the resource ID of the resource master 153. Data stored in each cost cell is a cost for carrying out each measure. Data stored in each after-measure RT cell is a recovery time of each resource after the measure is taken for the resource.

In the example of FIG. 8, the recovery time of each resource is reduced by taking a measure, so that the recovery time after carrying out each measure is set as the after-measure RT item. Alternatively, the after-measure RT item may be replaced by an item for setting a length or a reduction rate of the recovery time reduced by each measure.

Referring again to FIG. 2, the optimum measure selection unit 146 extracts the resources included in the resource path selected by the recovery time capability calculation unit 144 one by one, and calculates an evaluation value E of an effect of each of the measures to be taken to the extracted resources according to the following equation.

E=ΔT×N/C×Z

In the equation, ΔT denotes the length of the recovery time of the resource reduced by the measure. Specifically, ΔT denotes a difference between the recovery time capability of each resource, i.e., a value of the resource RT of the resource stored in the resource path data 154 and the recovery time of the resource after carrying out the measure, i.e., a value of the after-measure RT stored in the measure data 156.

Moreover, N denotes the number of resource included in the resource path data 154. In the influence diagram shown in FIG. 1, for example, the resource commercial power 32 is connected to the higher resources via the four paths, respectively. In the example of the resource path data 154 shown in FIG. 6, the resource ID “R005” representing the resource commercial power 32 appears four times.

In this way, if a measure is taken to the resource shared among different resource paths and the recovery time of the resource is reduced, the effect of reduction spreads to all the different resource paths sharing the resource. Due to this, according to the equation of E=ΔT×N/C×Z, the length of the recovery time of the resource reduced by the measure is multiplied by the number of times of sharing the resource, whereby the effect of the measure taken to the resource shared among the different resource paths is given a high evaluation value.

Moreover, C denotes a cost for taking the measure. Specifically, C denotes a value of the cost of the measure taken to the resource and stored in the measure data 156. In the equation of E=ΔT×N/C×Z, the length of the recovery time reduced by taking the measure is divided by the cost, thereby making it possible to evaluate a magnitude of the effect on the cost.

Further, Z denotes an effect coefficient. The effect coefficient is a coefficient indicating a reduction rate of the effect if the same type of measure are taken to the same type of resource a plurality of times and acquired by the effect coefficient acquisition unit 147. For example, various measures are taken to recover supply of power such as installing private power generation facilities for emergency and introduction of an uninterruptible power supply, fault-tolerant device. If these measures are applied in a superimposed manner, the effect obtained is gradually reduced. By using the effect coefficient, it is possible to rationalize the effect of application of these similar measures in a superimposed manner.

The equation of E=ΔT×N/C×Z is given only for illustrative purposes and may be appropriately changed according to purpose. For example, if it is important to hold down the cost during selection of measures, C may be replaced by a value that is a square of the cost.

Referring again to FIG. 2, the optimum measure selection unit 146 evaluates the effects of all measures that can be taken to each of the resources included in the resource path selected by the recovery time capability calculation unit 144 using the equation of E=ΔT×N/C×Z, and stores information on the measures for which a highest evaluation value is given in the optimum measure data 157. Further, the optimum measure selection unit 146 rewrites the value of the resource RT of each of the resources included in the resource path data 154 to a value after taking the measure. Specifically, the value of the resource RT corresponding to the resource to which measure is taken is replaced by the value of the after-measure RT.

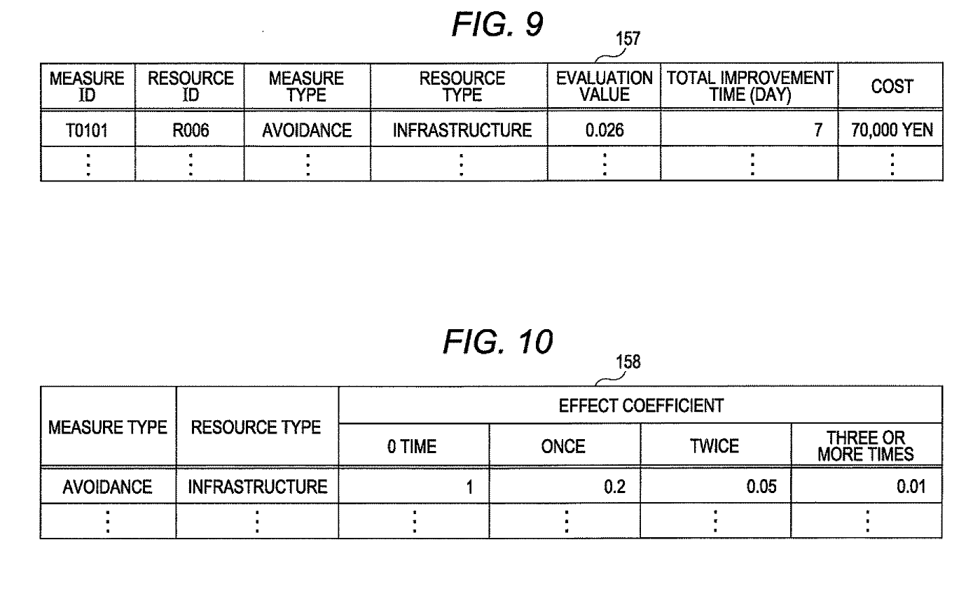

FIG. 9 shows an example of the optimum measure data 157. As shown in FIG. 9, the optimum measure data 157 includes such items as a measure ID item, a resource ID item, a measure type ID item, a resource type item, an evaluation value item, a total improvement time item, and a cost item. Whenever the optimum measure selection unit 146 selects a measure, data shown in each row is added.

Data stored in each measure ID cell is an identification number for identifying each measure, and corresponds to the measure ID stored in the measure data 156. Data stored in each resource ID cell is an identification number indicating each resource to which a measure are taken, and corresponds to the resource ID stored in the resource master 153. Data stored in each measure type cell is a type of each measure. Data stored in each resource type cell is a type of each resource. Data stored in each evaluation value cell, data stored in each total improvement time cell, and data stored in each cost cell correspond to E, ΔT×N, and C in the equation of E=ΔT×N/C×Z, respectively.

Referring again to FIG. 2, the effect coefficient acquisition unit 147 is a processing unit that acquires, from the measure effect master 158, an effect coefficient of a measure the effect of which the optimum measure selection unit 146 is to evaluate. FIG. 10 shows an example of the measure effect master 158. As shown in FIG. 10, the measure effect master 158 includes such items as a measure type item, a resource type item, and an effect coefficient item, and is configured to be able to register different effect coefficients according to respective combinations of the measure type and the resource type. The effect coefficient is configured to be able to be set to a value according to the number of effect coefficients such as zero, once, twice or three times or more.

Referring again to FIG. 2, the effect coefficient acquisition unit 147 counts the number of rows identical in measure type to the measure the effect of which the optimum measure selection unit 146 is to evaluate and identical in resource type to the resource to which the measure is to be taken while referring to the optimum measure data 157, thereby acquiring the number of times by which the optimum measure data 157 already selects similar measures. Further, the effect coefficient acquisition unit 147 acquires the effect coefficient indicating the number of times in the row which coincide in measure type and resource type while referring to the measure effect master 158.

The result output unit 148 is a processing unit that outputs contents of the optimum measure data 157 after the RTCs of all the resource paths included in the resource path data 154 are below the RTO to attain the RTO. A manner of output can be appropriately changed according to the purpose.

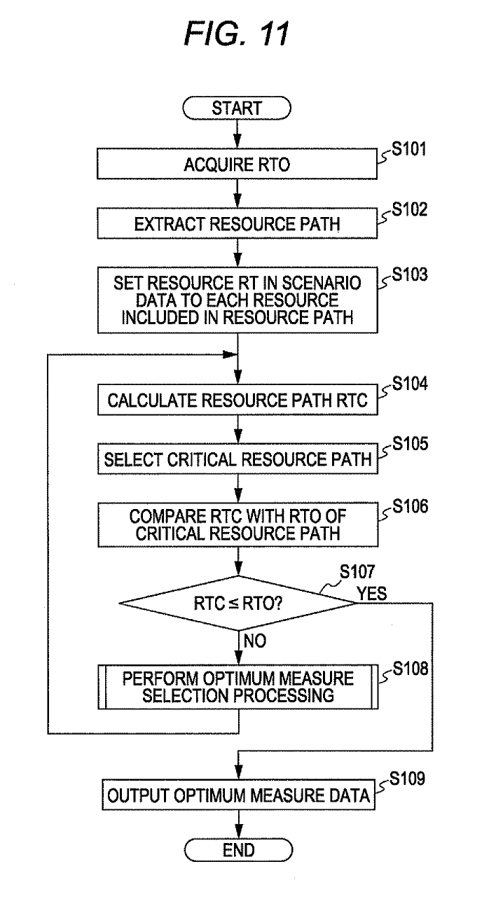

Processing procedures of the measure selection apparatus 100 will next be described. FIG. 11 is a flowchart showing processing procedures performed by the measure selection apparatus 100. As shown in FIG. 11, the measure selection apparatus 100 acquires the RTO via the input unit or the like (operation S101). The resource path extraction unit extracts resource paths from the operation element data and the operation element related data, and stores the resource paths in the resource path data (operation S102). The recovery time initial setting unit sets the recovery time of each resource in the scenario data (operation S103).

The recovery time capability calculation unit calculates RTCs of the respective resource paths according to an instruction of the measure selection process control unit (operation S104). The critical path selection unit selects a resource path having the highest RTC (operation S105). At this time, the measure selection process control unit compares the RTO with the RTC of the selected resource path (operation S106). If the RTC is higher than the RTO (operation S107, NO), then the measure selection process control unit controls the optimum measure selection unit to perform an optimum measure selection process, to be described later (operation S108), and the process is restarted at the operation S104.

On the other hand, if the RTC is equal to or lower than the RTO (operation S107, YES), the result output unit outputs contents of the optimum measure data and the process is completed (operation S109).

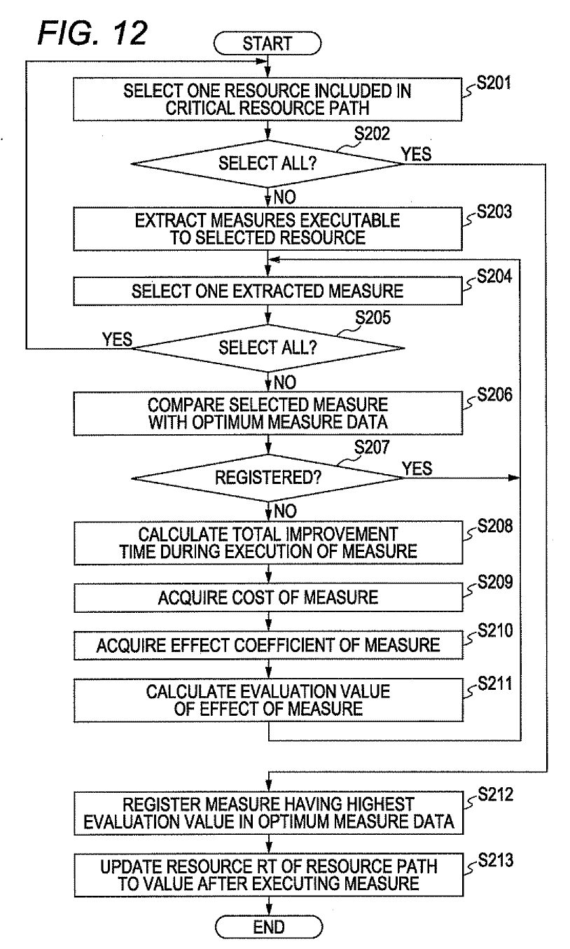

FIG. 12 is a flowchart showing processing procedures for the optimum measure selection process. As shown in FIG. 12, the optimum measure selection unit selects one unselected resource from among the resources included in the resource path selected by the critical path selection unit (operation S201). If the optimum measure selection unit can select the unselected resource (operation S202, NO), the optimum measure selection unit extracts measures executable to the resource from the measure data (operation S203).

The optimum measure selection unit selects one unselected measure from among the extracted measures (operation S204). If the optimum measure selection unit can select one unselected measure (operation S205, NO), the optimum measure selection unit compares the selected measure with the optimum measure data (operation S206). If the selected measure is already registered in the optimum measure data, that is, the measure is already selected as one of the optimum measures (operation S207, YES), the process returns to the operation S204 to try selecting a next measure so as to avoid repeatedly selecting the selected measure.

If the selected measure is not registered in the optimum measure data (operation S207, NO), then the optimum measure selection unit calculates total improvement time (ΔT×N in the equation E=ΔT×N/C×Z) at the time of executing the measure (operation S208), and acquires the cost (C in the equation E=ΔT×N/C×Z) (operation S209). Further, the optimum measure selection unit causes the effect coefficient acquisition unit to acquire the effect coefficient (Z in the equation E=ΔT×N/C×Z) (operation S210), and calculates the evaluation value of the effect of the measure (operation S211).

In this manner, the optimum measure selection unit repeatedly executes the process from the operation S204 to S211. If the optimum measure selection unit finishes evaluating effects of all the measures extracted at the operation S203 (operation S205, YES), then the process returns to the operation S201 at which the optimum measure selection unit selects a next unselected resource, and the process is performed again after the operation S201.

If the optimum measure selection unit finishes all the resources (operation S202, YES), the optimum measure selection unit registers information on the measure having the highest evaluation value in the optimum measure data (operation S212), updates values of the resource RT in the resource path data to values after executing the measure, and finishes the process (operation S213).

The configuration of the measure selection apparatus 100 according to the embodiment shown in FIG. 2 can be changed variously in a range without departure from the concept of the present invention. For example, by installing functions of the control unit 140 of the measure selection apparatus 100 as software and causing a computer to execute the software function, it is possible to realize functions equivalent to those of the measure selection apparatus 100. An example of the computer executing a measure selection program having the functions of the control unit 140 installed as software will now be described.

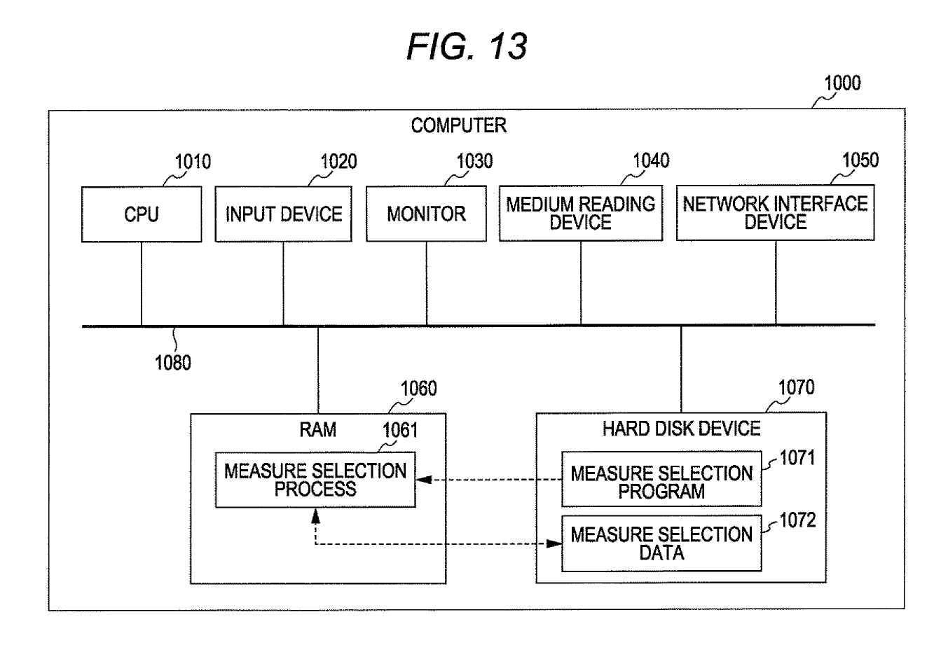

FIG. 13 is a functional block diagram showing a computer 1000 executing the measure selection program 1071. The computer 1000 is configured so that a CPU (central processing unit) 1010 executing various calculation processes, an input device 1020 to which a user inputs data, a monitor 1030 displaying various information, a medium reading device 1040 reading programs and the like from a recording medium, a network interface device 1050 transmitting or receiving data to or from the other computer via a network, a RAM (random access memory) 1060 temporarily storing various information, and a hard disk device 1070 are connected to one another by a bus 1080.

The measure selection program 1071 similar in function to the control unit 140 shown in FIG. 2 and measure selection data 1072 corresponding to the various data stored in the storage unit 150 shown in FIG. 2 are stored in the hard disk device 1070. Alternatively, the measure selection data 1072 can be appropriately stored in the other computer connected to the computer 1000 via the network.

The CPU 1010 reads the measure selection program 1071 from the hard disk device 1070 and expands the measure selection program 1071 in the RAM 1060, whereby the measure selection program 1071 can function as a measure selection process 1061. The measure selection process 1061 appropriately expands information and the like read from the measure selection data 1072 in an area allocated to the process 1061 on the RAM 1060, and executes various data processing based on the expanded data and the like.

The measure selection program 1071 is not necessarily stored in the hard disk device 1070 but may be stored in a storage medium such as a CD-ROM so that the computer 1000 reads the measure selection program 1071 from the storage medium and executes the program 1071. In another alternative, the measure selection program 1071 may be stored in the other computer (or server) or the like connected to the computer 1000 via a public line, the Internet, a LAN (local area network), a WAN (wide area network) or the like, and the computer 1000 may read the measure selection program 1071 from the other computer or the like and execute the program 1071.

As stated so far, according to the embodiment, the resource paths constituting the influence diagram are extracted and the recovery time is improved for every path, thereby realizing improvements in the overall recovery time. Due to this, even if the business contents expressed by the influence diagram are complicated, it is possible to efficiently select the optimum combination of measures.

Moreover, according to the embodiment, since the measures are evaluated based on their respective cost-to-effect ratios, it is advantageously possible to select the optimum combination of measures most excellent in balance between the cost and the effect. Further, according to the embodiment, if the same type of measures is already selected, evaluation value indicating the effect of the measure is set low. It is, therefore, advantageously possible to appropriately reflect a reduction in effect if the same type of measures is repeatedly selected in the selection of measures.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A storage medium storing a program for causing a computer to execute a process for selecting a combination of measures so as to set a recovery time of a business when a predetermined event occurs to be equal to or shorter than a time objective based on operation element related information showing a dependency relationship between an operation constituting the business and resources necessary to continue the operation, scenario information holding the recovery time required for a recovery when the predetermined event occurs for each of the resources, and measure information holding measures for reducing the recovery time and effects of the respective measures, the program causing the computer to execute:
a resource path extraction procedure of extracting paths connecting a highest node to a terminal node of the resources included in the operation element related information according to the dependency relationship; and
a measure selection process control procedure of controlling the process for selecting the combination of measures so that a recovery time sum of the respective resources is equal to or shorter than the time objective on all the paths extracted at the resource path extraction procedure.

2. The storage medium storing the program according to claim 1,
wherein the program causes the computer to further execute:
a critical path extraction procedure of selecting a path on which the recovery time sum of the resources is the greatest from among the paths extracted at the resource path extraction procedure; and
an optimum measure selection procedure of selecting measures each having a highest effect from among the measures made to correspond to the respective resources included in the path selected at the critical path extraction procedure and included in the measure information, and reflecting a reduction in recovery time by the selected measures in the resources corresponding to the respective measures, and
wherein at the measure selection process control procedure, a process for the critical path extraction procedure and a process for the optimum measure selection procedure are repeatedly performed until the recovery time sum of the resources is equal to or shorter than the time objective on all the paths extracted at the resource path extraction procedure.

3. The storage medium storing the program according to claim 2,
wherein a cost necessary to execute each of the measures and each of the measures are stored in the measure information so that the cost corresponds to each of the measures, and
at the optimum measure selection procedure, measures each having a highest cost-to-effect ratio are selected from among the measures made to correspond to the respective resources included in the path selected at the critical path extraction procedure and included in the measure information.

4. The storage medium storing the program according to claim 2,
wherein at the optimum measure selection procedure, measures equal in a resource type to the selected measures are made to correspond to the respective selected measures, and if a number of times of selecting the measures equal in the resource type to the selected measures increases, the effect of each of the selected measures is reduced.

5. The storage medium storing the program according to claim 2,
wherein at the optimum measure selection procedure, if more resources made to correspond to the respective selected measures are included in the paths extracted at the resource path extraction procedure, the effect of each of the selected measures is increased.

6. A measure selection apparatus for selecting a combination of measures so as to set a recovery time of a business when a predetermined event occurs to be equal to or shorter than a time objective based on operation element related information showing a dependency relationship between an operation constituting the business and resources necessary to continue the operation, scenario information holding the recovery time required for a recovery when the predetermined event occurs for each of the resources, and measure information holding measures for reducing the recovery time and effects of the respective measures, the measure selection apparatus comprising:
resource path extraction means for extracting paths connecting a highest node to a terminal node of the resources included in the operation element related information according to the dependency relationship; and
measure selection process control means for controlling the process for selecting the combination of measures so that a recovery time sum of the respective resources is equal to or shorter than the time objective.

7. The measure selection apparatus according to claim 6, further comprising:
critical path extraction means for selecting a path on which the recovery time sum of the resources is the greatest from among the paths extracted by the resource path extraction means; and
optimum measure selection means for selecting measures each having a highest effect from among the measures made to correspond to the respective resources included in the path selected by the critical path extraction means and included in the measure information, and reflecting a reduction in recovery time by the selected measures in the resources corresponding to the respective measures, and
wherein the measure selection process control means causes the critical path extraction means and the optimum measure selection means to repeatedly perform respective process until the recovery time sum of the resources is equal to or shorter than the time objective on all the paths extracted by the resource path extraction means.

8. The measure selection apparatus according to claim 7,
wherein a cost necessary to execute each of the measures and each of the measures are stored in the measure information so that the cost corresponds to each of the measures, and
the optimum measure selection means selects measures each having a highest cost-to-effect ratio from among the measures made to correspond to the respective resources included in the path selected by the critical path extraction means and included in the measure information.

9. The measure selection apparatus according to claim 7,
wherein the optimum measure selection means makes measures equal in a resource type to the selected measures correspond to the respective selected measures, and reduces the effect of each of the selected measures if a number of times of selecting the measures equal in the resource type to the selected measures increases.

10. The measure selection apparatus according to claim 7,
wherein the optimum measure selection means increases the effect of each of the selected measures if more resources made to correspond to the respective selected measures are included in the paths extracted by the resource path extraction means.

11. A measure selection method for selecting a combination of measures so as to set a recovery time of a business when a predetermined event occurs to be equal to or shorter than a time objective based on operation element related information showing a dependency relationship between an operation constituting the business and resources necessary to continue the operation, scenario information holding the time required for a recovery when the predetermined event occurs for each of the resources, and measure information holding measures for reducing the recovery time and effects of the respective measures, the method comprising:
a resource path extraction operation of extracting paths connecting a highest node to a terminal node of the resources included in the operation element related information according to the dependency relationship; and
a measure selection process control operation of controlling the process for selecting the combination of measures so that a recovery time sum of the respective resources is equal to or shorter than the recovery time objective on all the paths extracted at the resource path extraction operation.

12. The measure selection method according to claim 11, further comprising:
a critical path extraction operation of selecting a path on which the recovery time sum of the resources is the greatest from among the paths extracted at the resource path extraction operation; and
an optimum measure selection operation of selecting measures each having a highest effect from among the measures made to correspond to the respective resources included in the path selected at the critical path extraction operation and included in the measure information, and reflecting a reduction in recovery time by the selected measures in the resources corresponding to the respective measures, and
wherein at the measure selection process control operation, a process for the critical path extraction operation and a process for the optimum measure selection operation are repeatedly performed until the recovery time sum of the resources is equal to or shorter than the recovery time objective on all the paths extracted at the resource path extraction operation.

13. The measure selection method according to claim 12,
wherein a cost necessary to execute each of the measures and each of the measures are stored in the measure information so that the cost corresponds to each of the measures, and
at the optimum measure selection operation, measures each having a highest cost-to-effect ratio are selected from among the measures made to correspond to the respective resources included in the path selected at the critical path extraction operation and included in the measure information.

14. The measure selection method according to claim 12,
wherein at the optimum measure selection operation, measures equal in a resource type to the selected measures are made to correspond to the respective selected measures, and if a number of times of selecting the measures equal in the resource type to the selected measures increases, the effect of each of the selected measures is reduced.

15. The measure selection method according to claim 12,
wherein at the optimum measure selection operation, if more resources made to correspond to the respective selected measures are included in the paths extracted at the resource path extraction operation, the effect of each of the selected measures is increased.
